(19) United States
(12) Patent Application Publication
(10) Pub. No.: US 2025/0033207 A1
(43) Pub. Date: Jan. 30, 2025

(54) CONTROL DEVICE FOR ROBOT THAT COMMUNICATES WITH PROGRAMMABLE LOGIC CONTROLLER

(71) Applicant: FANUC CORPORATION, Yamanashi (JP)

(72) Inventor: Tomoki KATO, Yamanashi (JP)

(21) Appl. No.: 18/716,142

(22) PCT Filed: Feb. 9, 2022
(86) PCT No.: PCT/JP2022/005168

§ 371 Date: Jun. 4, 2024

(51) Int. Cl. B25J 9/16

(52) U.S. Cl. CPC B25J 9/1656

(57) ABSTRACT

A control device of a robot according to the present invention stores a basic file in which the data type of variables for communicating with a PLC is defined. The control device generates, on the basis of the basic file, a definition file in which the data type of the variables is defined in a file format which can be read by the PLC. The control device is formed so as to carry out periodic digital communication for transmitting information pertaining to the variables. The control device allocates, on the basis of the data type of the variables defined in the basic file, areas for variables in an input area and an output area of a memory that is included in a storage unit.

### RELATED APPLICATIONS

The present Application is a National Phase of International Application No. PCT/JP2022/005168 filed Feb. 9, 2022.

### TECHNICAL FIELD

The present invention relates to a controller of a robot for communicating with a programmable logic controller.

### BACKGROUND ART

In a device including a machine, a switch, a sensor, and the like are arranged in order to control a drive machine, such as a motor, included in the device. A programmable logic controller (PLC) is known as a device for controlling the order in which the drive machines included in the device are caused to operate, in accordance with an output of the sensor, an operation of a peripheral machine, or the like (e.g., Japanese Unexamined Patent Publication No. 2005-141435A). The programmable logic controller controls the order of operations such as starting and stopping of the drive machines, and reception of a signal from the sensor or the switch (e.g., Japanese Unexamined Patent Publication No. 2002-269024A).

When the programmable logic controller controls a device including a robot, the programmable logic controller performs data communication with a controller of the robot (e.g., Japanese Unexamined Patent Publication No. 2019-159995A). For a variable used for the communication between the controller of the robot and the programmable logic controller, a data type, such as an integer type and a character string type, is specified in advance in order to perform the communication. In order to communicate the variable of the predetermined data type, it is necessary to specify a definition of the data type.

### CITATION LIST

### Patent Literature

PTL 1: Japanese Unexamined Patent Publication No. 2005-141435A
PTL 2: Japanese Unexamined Patent Publication No. 2002-269024A
PTL 3: Japanese Unexamined Patent Publication No. 2019-159995A

### SUMMARY OF INVENTION

### Technical Problem

When a variable of a predetermined data type is communicated between a programmable logic controller and a controller of a robot, as preparatory work, it is necessary to manually set a definition of the data type in the programmable logic controller, and further to manually set the definition of the data type in the controller of the robot. Therefore, it takes time to set the data type of the variable. Alternatively, it is conceivable to transfer the definition of the data type of the variable by specifying a model of the robot and a model of the PLC and performing communication using a dedicated communication protocol. However, with this method, there is a problem in that the model of the robot and the model of the PLC that can be used are limited.

### Solution to Problem

An aspect of the present disclosure is a controller of a robot, the controller performing communication with a programmable logic controller. The controller includes a storage configured to store a basic file in which a data type of a variable for performing communication between a programmable logic controller and a controller is specified. The controller includes a definition file generating unit configured to generate, in a file format readable by the programmable logic controller, a definition file in which the data type of the variable is specified, based on the basic file. The controller includes a transfer unit configured to perform periodic digital communication in order to transfer information relating to the variable when driving the robot. The controller includes a memory allocation unit configured to allocate, based on the data type of the variable specified in the basic file, a variable region to an input region for inputting the variable and an output region for outputting the variable in a memory included in the storage.

### Advantageous Effects of Invention

According to an aspect of the present disclosure, a controller of a robot can be provided that easily performs setting for transferring a variable between the controller of the robot and a programmable logic controller.

### BRIEF DESCRIPTION OF DRAWINGS

FIG. 1 is a perspective view of a robot device in an embodiment.

FIG. 2 is a block diagram of the robot device.

FIG. 3 is a flowchart of a preparatory work carried out before actual work is performed by the robot device.

FIG. 4 is a schematic diagram when a controller main body outputs a data-type definition file for a PLC.

FIG. 5 is a schematic diagram when the PLC reads the definition file and sets a definition of the data type.

FIG. 6 is a schematic diagram when a processing unit of the controller main body allocates an input region and an output region of a memory.

FIG. 7 is a screen showing allocation of indexes of the input region and the output region of the memory.

FIG. 8 is a block diagram of the controller main body and the PLC describing transmission of variables when the robot device carries out the actual work.

FIG. 9 is a flowchart describing transmission of information relating to the variables from the controller main body to the PLC.

FIG. 10 is a flowchart describing transmission of the information relating to the variables from the PLC to the controller main body.

### DESCRIPTION OF EMBODIMENTS

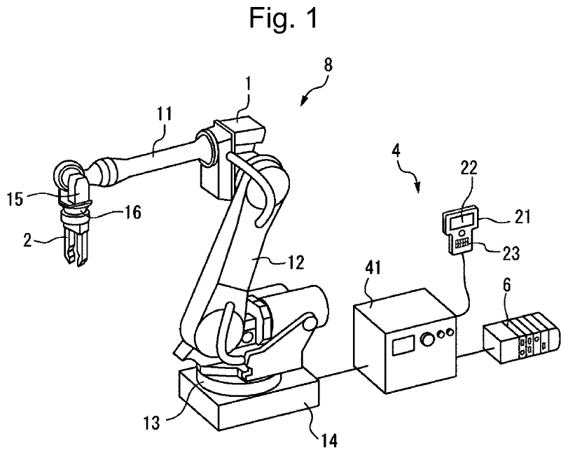

A controller of a robot according to an embodiment will be described with reference to FIGS. 1 to 10. A robot device according to the present embodiment includes a programmable logic controller (hereinafter referred to as “PLC”), a robot, and a controller of the robot. The controller of the robot is configured to transfer information relating to predetermined variables between the controller and the PLC.

FIG. 1 is a perspective view of a robot device in the present embodiment. A robot device 8 of the present embodiment carries out a work of transporting a workpiece based on an operation program. The robot device 8 includes a work tool 2 and a robot 1 that moves the work tool 2. The work tool 2 is a hand that grips the workpiece. The robot 1 is an articulated robot having a plurality of joints.

The robot 1 includes a turning base 13 supported by a base 14. The turning base 13 is formed so as to rotate with respect to the base 14. The robot 1 includes an upper arm 11 and a lower arm 12 rotatably supported via the joint. Further, the upper arm 11 rotates about a rotation axis parallel to the extending direction of the upper arm 11. The robot 1 includes a wrist 15 rotatably supported at an end portion of the upper arm 11. The wrist 15 includes a flange 16 that is formed so as to be rotatable. The work tool 2 is fixed to the flange 16 of the wrist 15. The robot 1 according to the present embodiment includes six drive axes, but is not limited to this configuration. Any robot capable of moving the work tool can be employed.

The work tool 2 of the present embodiment is a hand including two claw parts, but is not limited to this configuration. Any work tool can be attached to the robot 1 in accordance with work performed by the robot device. For example, when the robot device performs arc welding, a welding torch can be attached to the robot.

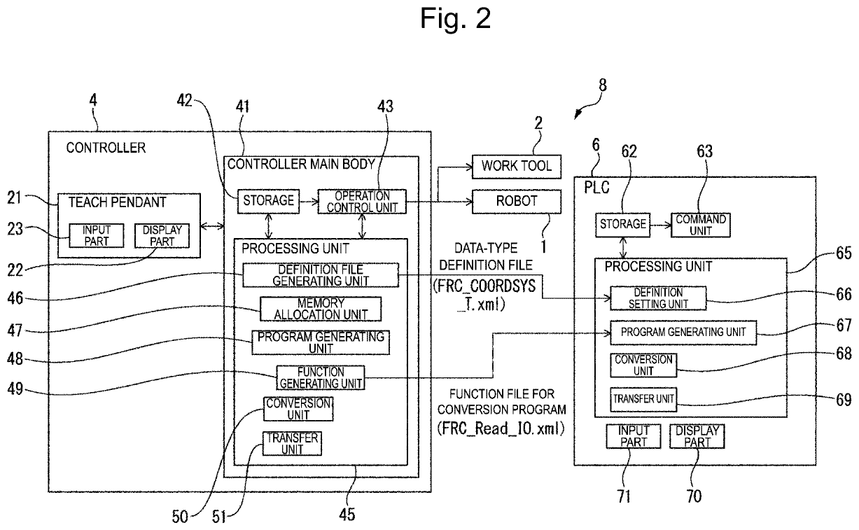

FIG. 2 illustrates a block diagram of the robot device according to the present embodiment. Referring to FIG. 1 and FIG. 2, the robot 1 includes a robot drive device that changes a position and an orientation of the robot 1. The robot drive device includes a motor as a drive machine that drives a component such as the arm and the wrist. The work tool 2 includes a tool drive device that drives the work tool 2. The tool drive device includes a pressurizing pump as a drive machine that drives the claw parts of the work tool 2.

The robot device 8 includes a controller 4 of the robot. The controller 4 includes a controller main body 41 that includes an arithmetic processing device (computer) including a central processing unit (CPU) as a processor.

The arithmetic processing device of the controller main body 41 includes a storage 42 that stores predetermined information. The storage 42 stores information related to control of the robot 1 and the work tool 2. The storage 42 may be constituted by a non-transitory storage medium capable of storing information. For example, the storage 42 may be constituted by a storage medium such as a volatile memory, a nonvolatile memory, a magnetic storage medium, or an optical storage medium.

The storage 42 includes a memory as a storage device that communicates information with the processor. The memory of the present embodiment is constituted by a static random access memory (SRAM) which is a volatile memory. The memory is connected to the processor via a bus. In addition to the SRAM, the storage 42 may include, for example, a dynamic random access memory (DRAM) and a ferroelectric random access memory (FRAM) (registered trademark) that stores a back up of the operation program. Alternatively, the storage 42 may include a register arranged inside the CPU.

The arithmetic processing device of the controller 4 includes an operation control unit 43 that sends an operation command. The operation control unit 43 corresponds to a processor that is driven in accordance with the operation program. The operation control unit 43 is formed so as to be able to read the information stored in the storage 42. The operation program is stored in a memory of the storage 42, for example. Based on the operation program, the operation control unit 43 sends an operation command for driving the robot 1, to an electric circuit that supplies electricity to the robot drive device. Based on the operation program, the operation control unit 43 sends an operation command for driving the work tool 2, to an electric circuit that supplies electricity to the tool drive device. The robot 1 and the work tool 2 are driven based on the operation program.

The controller 4 includes a teach pendant 21 for an operator to manually drive the robot 1, input information necessary for control, and confirm the information necessary for control. The teach pendant 21 includes a display part 22 that displays information related to control of the robot device 8, and an input part 23 constituted by an input device such as a keyboard, a dial, and the like. The display part 22 can be configured by a display panel such as a liquid crystal display panel. The teach pendant 21 is electrically connected to the controller main body 41.

The robot device 8 includes a PLC 6 that controls operations of the robot 1 and the work tool 2. The PLC 6 performs control to drive a plurality of drive machines in a predetermined order. The PLC 6 receives signals from a sensor, a switch, or the like. The PLC 6 sends, to the controller main body 41, a command to start or stop the operation of the drive machine, start or stop the operation program, or correct an operation. Arbitrary input devices and output devices are connected to the PLC. A machine, a sensor, or the like other than the controller 4 of the robot may be connected to the PLC.

In the present embodiment, data types of variables for performing communication between the controller 4 and the PLC 6 are predetermined. The data types of the variables are specified in order to transfer information relating to variables related to the control of the robot. Definitions of the data types of the variables specified in the controller 4 are the same as definitions of the data types of the variables specified in the PLC. In other words, data communication is performed using the variables having the common data types. Examples of the data type of the variable include an integer type, a real number type, and a character string type. As will be described later, a basic file including information relating to the data types of the variables used for controlling the robot is generated by the operator and stored in the memory of the storage 42 of the controller main body 41.

The arithmetic processing device of the controller main body 41 includes a processing unit 45 that performs information processing and arithmetic operations. The processing unit 45 includes a definition file generating unit 46 that generates a definition file in which the data types of the variables are specified, in a file format readable by the PLC. The definition file generating unit 46 generates the definition file, based on the basic file in which the data types of the variables generated by the operator are specified. The processing unit 45 includes a memory allocation unit 47 that allocates variable regions to an input region for input of the variables and an output region for output of the variables in the memory. The memory allocation unit 47 carries out a work of allocating indexes for each of the variables to the input region and the output region, based on the data type of the variable specified in the basic file.

The processing unit 45 includes a conversion unit 50 that performs data conversion when the robot device 8 communicates in order to carry out the actual work. The processing unit 45 includes a program generating unit 48 that generates a conversion program that performs conversion between information relating to the variable based on the data type and a periodic digital communication signal. The program generating unit 48 generates a conversion program for driving the conversion unit 50. The conversion unit 50 performs conversion between the information relating to the variable based on the data type and the periodic digital communication signal, based on the conversion program generated by the program generating unit 48.

The processing unit 45 includes a function generating unit 49 that generates a function file for the PLC 6 to generate a conversion program. Similarly to the conversion program of the controller main body 41, the conversion program generated in the PLC 6 is a program for performing conversion between the information relating to the variable based on the data type and the periodic digital communication signal.

The processing unit 45 includes a transfer unit 51 that performs periodic digital communication in order to transfer the information relating to the variables when driving the robot device 8. The robot device 8 according to the present embodiment adopts a method of periodically performing communication at a communication period (RPI) as a method of communication between the controller main body 41 and the PLC 6 when driving the robot device 8. For example, a method of communication referred to as implicit communication in the protocol of Ethernet/IP (registered trademark) corresponds thereto. In the communication between the controller main body 41 of the robot and the PLC 6, a digital signal constituted by a binary signal of ON or OFF is transferred.

The processing unit 45, the definition file generating unit 46, the memory allocation unit 47, the program generating unit 48, the function generating unit 49, the conversion unit 50, and the transfer unit 51 of the controller main body 41 correspond to a processor that is driven in accordance with a predetermined program. By the processor reading the program and performing control specified in the program, the processor functions as each of the units.

The PLC 6 of the present embodiment includes an arithmetic processing device including a CPU as a processor. The arithmetic processing device includes a storage 62 that stores predetermined information. The storage 62 may be constituted by a non-transitory storage medium capable of storing information. The storage 62 can include a plurality of storage media similarly to the storage 42 of the controller main body 41.

The storage 62 of the present embodiment includes an SRAM which is a memory connected to the processor via a bus. Further, the PLC 6 may include an auxiliary storage device (storage) arranged separately from a portion in which the processor and the memory are arranged. The auxiliary storage device is connected to the processor via a communication interface. Any information can be stored in the auxiliary storage device. Examples of the auxiliary storage device include a hard disk drive (HDD), a solid state drive (SSD), a flash memory, and an optical storage device.

The PLC 6 includes a command unit 63 that receives signals from a device, a sensor, a switch, and the like connected to the PLC 6, and that sends a command to the device connected to the PLC 6. The command unit 63 corresponds to a processor driven in accordance with a predetermined program of the PLC.

The arithmetic processing device of the PLC 6 includes a processing unit 65 that performs arithmetic operations and processing of information. The processing unit 65 includes a definition setting unit 66 that acquires a variable data-type definition file and sets the definitions of the data types of the variables in the PLC 6. The processing unit 65 includes a program generating unit 67 that generates a conversion program for performing conversion between the information relating to the variable based on the data type and the periodic digital communication signal. The program generating unit 67 reads the function file generated by the function generating unit 49 of the controller main body 41. The program generating unit 67 generates a conversion program used in the PLC 6 based on the function file.

The processing unit 65 includes a conversion unit 68 that performs conversion between the information relating to the variable based on the data type and the periodic digital communication signal. The conversion unit 68 performs conversion between the information relating to the variables and the digital communication signal, based on the conversion program generated by the program generating unit 67. The processing unit 65 includes a transfer unit 69 that is configured to perform periodic digital communication with the controller main body 41, in order to transfer the information relating to the variables when driving the robot device 8.

The processing unit 65, the definition setting unit 66, the program generating unit 67, the conversion unit 68, and the transfer unit 69 of the PLC 6 correspond to a processor that is driven in accordance with a predetermined program. By the processor reading the program and performing control specified in the program, the processor functions as each of the units.

The PLC 6 according to the present embodiment includes an input part 71 for the operator to directly input information to the PLC 6, and a display part 70 for displaying information related to the PLC 6. The input part 71 is constituted by an input device such as a keyboard, a button, and a dial. The display part 70 is constituted by a device such as a display panel that displays information.

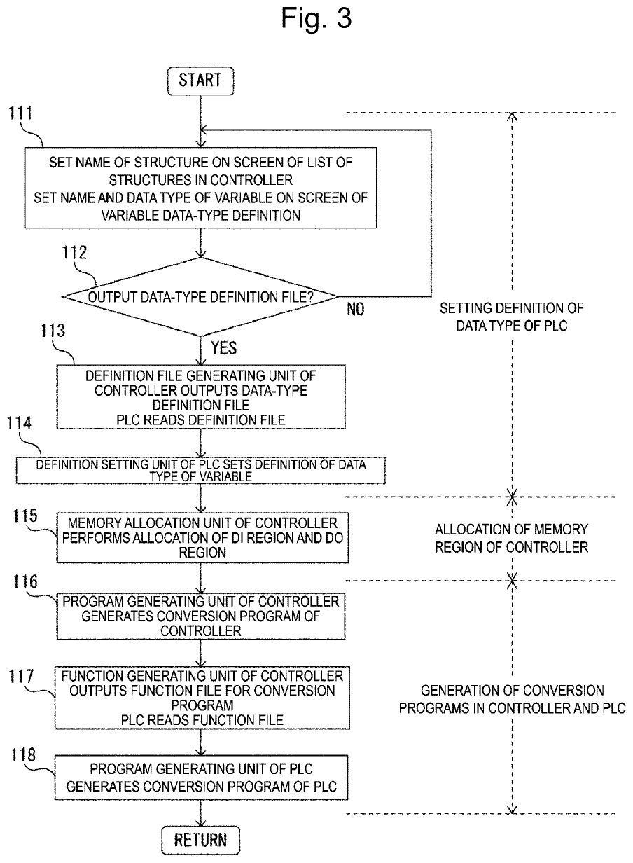

FIG. 3 is a flowchart of preparatory work in which setting of the robot device according to the present embodiment is performed. In the present embodiment, setting for communicating the variables between the controller main body 41 and the PLC 6 is performed. At steps 111 to 114, the definitions of the data types of the variables are set in the PLC 6. At step 115, the processing unit 45 of the controller main body 41 performs control for allocating a DI region and a DO region to the memory of the controller main body 41. The memory allocation unit 47 sets indexes used by each of the variables in the DI region for input signals and the DO region for output signals.

At steps 116 to 118, the conversion programs for converting the digital communication signal and the information relating to the variables are generated in the controller 4 and the PLC 6. Then, the conversion programs are stored in the storage 42 of the controller main body 41 and the storage 62 of the PLC 6. First, control for setting the definitions of the data types of the variables in the PLC 6 at steps 111 to 114 will be described.

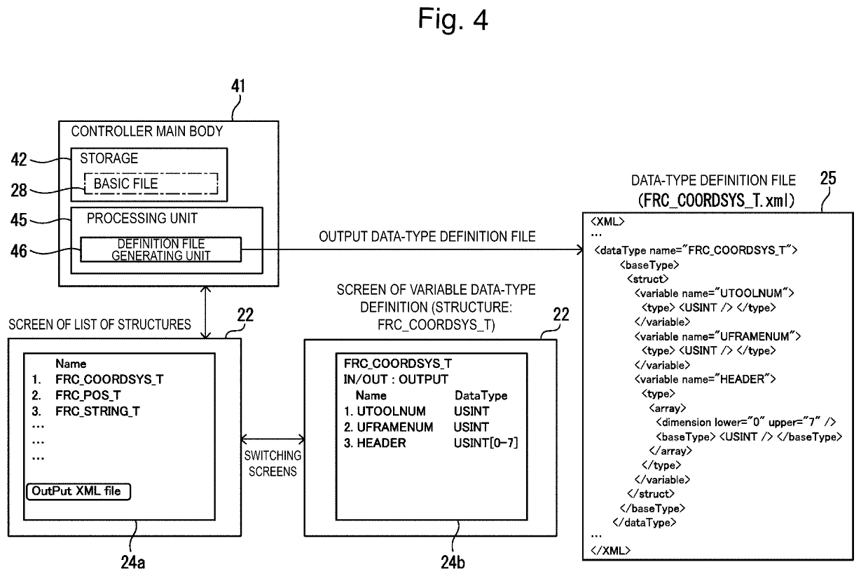

FIG. 4 is a schematic diagram describing generation of the variable data-type definition file for the PLC. Referring to FIGS. 3 and 4, at step 111, the operator sets, in the controller 4, a name of a structure, a name of the variable included in the structure, and a definition of the variable including the data type of the variable. The operator sets the name of the structure and the like by operating the input part 23 while viewing a screen displayed on the display part 22 of the teach pendant 21.

Images 24a and 24b are displayed on the display part 22 of the teach pendant 21. The image 24a is displayed on a screen of a list of a plurality of the structures including the variable. In the image 24a, names of three of the structures are displayed. The operator inputs the names of the structures by operating the input part 23. A structure FRC_COORDSYS_T is a structure including a coordinate system set in the robot device as the variable. A structure FRC_POS_T is a structure including a coordinate value of the coordinate system set in the robot device as the variable. A structure FRC_STRING_T is a structure including an error message as the variable. In this manner, the operator can set the names of the structures while viewing the list of the names of the plurality of structures. The names of the set structures are stored in the memory of the storage 42.

Subsequently, the operator selects one of the structures from the image 24a listing the names of the structures. The operator switches the screen displayed on the display part 22, to a screen of the definition of the data type of the variable. The image 24b showing the definitions of the variables is displayed on the display part 22. On the screen of the definition of the data type of the variable, the operator defines, under the item of “IN/OUT”, whether the variable included in the structure is a variable to be input to the controller 4, a variable to be output from the controller 4, or a variable to be input and output from the controller 4. Further, the operator inputs the name of the variable included in the structure and the definition of the data type of the variable. In the example of the image 24b here, the structure FRC_COORDSYS_T is selected.

In the image 24b, “OUTPUT” is designated in the item of “IN/OUT” displayed on the second line. As the definition of the variable, it is set that the variable included in this structure is output from the controller 4. When the variable is input to the controller 4, “INPUT” is set in the item of “IN/OUT”. Further, when the variable is the variable to be input to and output from the controller 4, “INOUT” is set in the item of “IN/OUT”.

Subsequently, the name of the variable included in the structure and the definition of the data type of the variable are set. The operator can input any name as the name of the variable. In this example, variables UTOOLNUM, UFRAMENUM, and HEADER are set as the variables included in the structure FRC_COORDSYS_T. The variable UTOOLNUM indicates the number of a tool coordinate system. UFRAMENUM indicates the number of a user coordinate system. The variable HEADER indicates a numerical value related to the orientation of the robot.

On the screen of the definition of the data type of the variable, the operator sets the definition of the data type of the variable included in the structure. The data type is set for each of the variables. For example, the data type of the variable UTOOLNUM is USINT, which is a non-negative integer type. With respect to the variable HEADER, an array of eight USINTs is specified. In other words, the variable HEADER is constituted by eight variables of the integer type. The set definition of the data type of the variable is stored as a basic file 28 in the memory of the storage 42. In this manner, the operator can set the name of each of the structures and the definition of each of the variables included in the structure by operating the input part 23 of the teach pendant 21.

Each of the structures can be selected in accordance with control performed by the controller. For example, the controller may select the first and second structures when executing one program, and may select the first to third structures when executing another program. Further, although the structure including a plurality of the variables is defined in the present embodiment, the configuration is not limited to this form, and the data type of the variable may be set without defining the structure.

In this regard, a standard (international standard: IEC61131-3) of an organization called PLCopen (registered trademark) aiming to promote efficient development of PLCs is known. The PLC manufactured in compliance with this standard can read a file in a format conforming to the standard, or can use a definition of a variable conforming to the standard. The PLC of the present embodiment is manufactured in compliance with the PLCopen standard. In this example, the operator sets the data type of the variable using the data type defined in the PLCopen standard.

The processing unit 45 of the present embodiment generates the basic file 28 including the definition of the data type of the variable specified in accordance with the operation of the operator. In the present embodiment, the basic file 28 is generated for each of the structures, as shown in the image 24b. The basic file 28 is stored in the memory of the storage 42. The basic file 28 is not limited to this form, and may be formed so as to include the definitions of the variables of a plurality of the structures. Alternatively, when the structure is not set, the basic file 28 may include the definition of the variable without including the name of the structure.

Subsequently, at step 112, the operator selects whether or not to output the variable data-type definition file. For example, when setting of some of the structures and the variables is not completed, the processing returns to step 111, and the operator repeats setting of the structure and the variable. When the variable data-type definition file is to be output, the operation proceeds to step 113. At step 113, the definition file generating unit 46 of the processing unit 45 outputs a data-type definition file 25. The PLC 6 reads the data-type definition file 25.

The operator selects one of the structures on the screen of the list of the structures. The operator presses a button of “OutPut XML file” for outputting the definition file, the button being arranged in the lower part of the image 24a. The definition file generating unit 46 of the processing unit 45 outputs the variable data-type definition file 25 for setting the data type of the variable in the PLC 6. The definition file generating unit 46 outputs the file in a format readable by the processing unit 65 of the PLC 6. In the present embodiment, the definition file generating unit 46 generates the data-type definition file for each of the structures. In this example, the data-type definition file 25 for the structure FRC_COORDSYS_T is generated.

Since the PLC 6 of the present embodiment is compliant with the PLCopen standard, the definition file generating unit 46 generates the definition file 25 in a file format specified by the standard. In this example, the definition file generating unit 46 outputs the variable data-type definition file 25 in the XML format.

The definition file generating unit 46 generates the variable data-type definition file 25 based on the basic file 28 in which the definition of the data type of the variable is set. The definition file generating unit 46 generates the data-type definition file 25 by arranging items specified in the basic file 28, such as the name of the structure, the name of the variable, and the data type of the variable, in a template (format) of the XML file. In this example, the definition file generating unit 46 outputs the definition file 25 whose file name is “FRC_COORDSYS_T.xml”.

In the variable data-type definition file 25, the name of the structure, the name of each of the variables, and the data type of each of the variables are specified in the XML format. In this case, definitions of the data types of the variable UTOOLNUM, the variable UFRAMENUM, and the variable HEADER are specified. By generating the definition file in the XML format compliant with PLCopen, the processing unit 65 of the PLC 6 can read the definition file 25 by using software stored in advance.

Note that the basic file 28 includes the information (IN/OUT) designating whether the variable is input to or output from the controller, and this designation of input and output is used for allocation of memory regions in the controller of the robot. In the present embodiment, the designation of input and output is not reflected in the data-type definition file 25.

In the present embodiment, the definition file generating unit 46 outputs one data-type definition file for one structure, but the configuration is not limited to this form, and a definition file including a plurality of structures may be output.

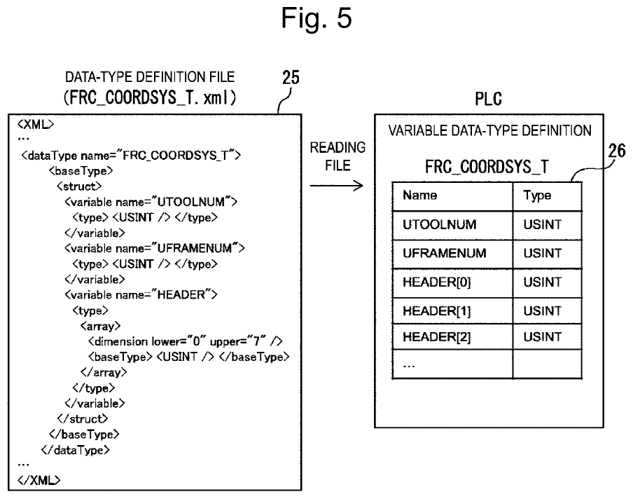

FIG. 5 is an explanatory diagram when the variable data-type definition file is read into the PLC. Referring to FIGS. 2, 3, and 5, at step 114, the definition setting unit 66 of the processing unit 65 of the PLC 6 automatically sets the definition of the data type of the variable in the PLC 6, based on the data-type definition file 25. The PLC 6 can read the definition file 25 generated by the definition file generating unit 46 using an arbitrary method. For example, the PLC 6 acquires the definition file 25 via a communication device. The definition setting unit 66 of the processing unit 65 of the PLC 6 acquires the data-type definition file 25.

Subsequently, the definition setting unit 66 acquires the definition of the data type of each of the variables from the data-type definition file 25 of the XML format, and sets the definition of the data type of each of the variables. The definition setting unit 66 stores the definition of the data type in the storage 62 of the PLC 6. In this case, a list 26 of the definitions of the data types of the variables included in the structure FRC_COORDSYS_T is illustrated. With respect to each of the variables such as the variable UTOOLNUM, the definition of the data type such as USINT is specified. The information relating to the definition of the data type of the variable can be stored in the memory of the storage 62, for example. In this regard, when a definition of another variable is already set in the PLC 6, the definition is added as a definition of a data type of a new variable.

In this manner, when the operator sets, in the basic file 28, the variables and the data types for communicating with the PLC 6 in the controller 4 of the robot, the controller 4 generates the variable data-type definition file 25 based on the basic file 28. The PLC 6 can read the variable data-type definition file 25, and can set the definition of the data type of the variable. In related art, it was necessary to manually set the definition of the data type of the variable in both the controller and the PLC. However, in the present embodiment, the definition of the data type of the variable in the PLC can be automatically set based on the definition of the data type input to the controller. Thus, setting of the PLC can be easily performed.

Referring to FIG. 3, subsequently, at step 115, the controller 4 automatically performs allocation of the memory regions. In the present embodiment, periodic digital communication is performed as a method of communicating the information relating to the variables between the controller main body 41 and the PLC 6. The periodic digital communication is a method of communication in which inputs and outputs are checked at predetermined intervals.

In the related art, message communication of a predetermined communication protocol is used for communicating information such as a character string. The message communication is a method of communication for transferring data at a specific timing, and is called explicit communication in the Ethernet/IP protocol. In the message communication, a dedicated parameter is required for each device and each communication protocol, and there is a problem in that setting of the parameters is difficult. On the other hand, in the periodic digital communication, setting of parameters for performing communication is easier than in the message communication. The periodic digital communication is a general-purpose communication method and supports many communication protocols. Therefore, the periodic digital communication can be implemented in devices of many manufacturers. In this regard, when the periodic digital communication is performed, it is necessary to allocate an input region and an output region in the memory of the controller 4 of the robot.

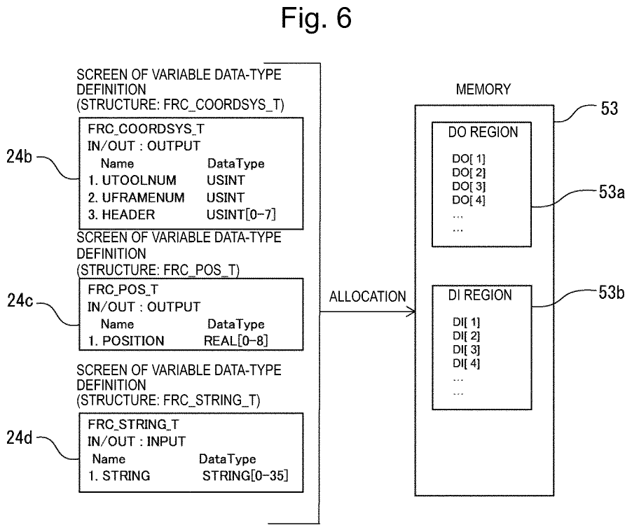

FIG. 6 is an explanatory diagram describing the variables included in the structures and the memory of the controller of the robot. FIG. 6 illustrates a screen of the definition of the data type of the variable displayed on the display part, and a schematic diagram of the memory of the controller. Images 24b, 24c, and 24d each showing the definition of the variable included in the structure are displayed on the screen of the definition of the data type of each of the variables.

In the images 24b and 24c, the variables of the structure FRC_COORDSYS_T and the variables of the structure FRC_POS_T, which serve as DO signals output from the controller main body 41, are shown. In the image 24c, the variable of the structure FRC_STRING_T, which serves as a DI signal input from the PLC 6 to the controller main body 41, is shown. The definitions of these variables are specified in the basic file 28 and stored in the memory of the storage 42.

With respect to each of the variables, it is necessary to secure a region of the memory 53 of the controller main body 41 in accordance with the data type. With respect to the region of the memory 53, the operator allocates a DO region 53a that is a region for storing signals of a variable to be output, and a DI region 53b that is a region for storing signals of a variable to be input. In this case, an index such as DO [1], DO [2], and DO [3] is assigned to each bit of the DO region 53a, for example. A binary signal of “0” or “1”, that is, an “ON” or “OFF” signal can be stored in one index. Further, an index such as DI [1], DI [2], and DI [3] is assigned to each bit of the DI region 53b, for example.

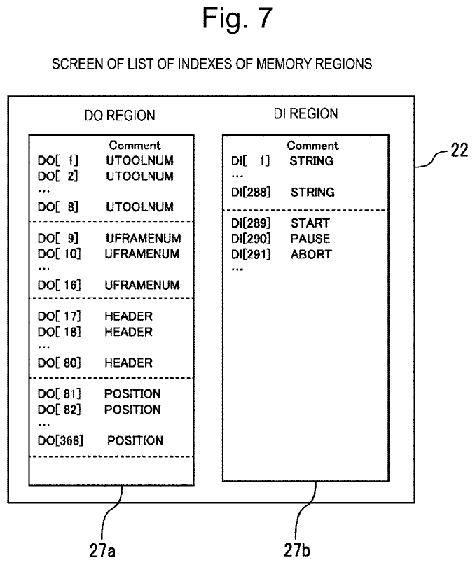

FIG. 7 shows a screen of a list of the indexes allocated to the DO region and the DI region displayed by the display part. In FIG. 7, images 27a and 27b are shown which show the allocation of the memory regions to each of the variables of the structures. The operator can allocate in advance an input region DI for input of variables, and an output region DO for output of variables in the memory 53. In this example, the image 27a related to the allocation of the DO region 53a and the image 27b related to the allocation of the DI region 53b are displayed on the display part 22 of the teach pendant 21. In the images 27a and 27b, the indexes of the memory 53 such as DO [1], which are allocated corresponding to the variables of the structures, are shown. In addition, the names of the variables are automatically displayed in a comment field so that the variables corresponding to the respective indexes can be understood. For example, DO [1] to DO [8] are allocated to the variable UTOOLNUM of the structure FRC_COORDSYS_T.

Referring to FIGS. 6 and 7, the memory allocation unit 47 of the processing unit 45 sets bit strings of the variables in the DO region 53a and the DI region 53b of the memory 53. Signals output from the controller 4 are allocated to the DO region 53a. For example, in the structure FRC_COORDSYS_T shown in the image 24b, “OUTPUT” is designated in the item IN/OUT. The variables included in the structure FRC_COORDSYS_T are set in the DO region 53a. Signals input to the controller 4 are allocated to the DI region 53b. For example, in the structure FRC_STRING_T shown in the image 24d, “INPUT” is designated in the item IN/OUT. The variable STRING included in the structure FRC_STRING_T is set in the DI region 53b.

The memory allocation unit 47 secures the bit string in accordance with the data type of the variable. For example, if the data type is USINT, a digital communication signal can be represented by eight bits. By using the eight bits, 256 numbers from 0 to 255 can be used. For the variable UTOOLNUM shown in the image 24b, the indexes DO [1] to DO [8] are set in the DO region 53a, and indexes DO [9] to DO [16] are set for the variable UFRAMENUM.

USINT [0-7], which is the data type of the variable HEADER shown in the image 24b, has eight 8-bit arrays. In other words, 64 indexes are required in the DO region 53a. For the variable HEADER, indexes from DO [17] to DO [80] are set. A data type REAL of a variable POSITION in the image 24c indicates a real number type. For example, the variable of the real number type uses 32 bits. In this case, since the variable of the real number type having nine numbers from 0 to 8 is defined, 32×9=288 indexes are required. For the variable POSITION, indexes from DO [81] to DO [368] are set.

A data type STRING of the variable STRING displayed in the image 24d indicates the character string type. One variable of the data type STRING uses 8 bits. In this case, since it is defined that there are 36 variables, 8×36=288 indexes are required. For the variable STRING, indexes from DI [1] to DI [288] are set in the DI region 53b.

In this manner, the memory allocation unit 47 calculates a necessary bit string in accordance with each of the data types, and automatically allocates the bit string to the DO region 53a or the DI region 53b. The memory allocation unit 47 performs allocation such that a bit string used as a variable is constituted by indexes having continuous numbers. Further, the indexes are set in order so that the index numbers are not skipped from the index having the smallest number. By performing this control, it is possible to efficiently use the region of the memory without waste.

Note that when input and output of a variable are designated on the screen of the variable data-type definition (see the images 24b, 24c, and 24d in FIGS. 4 and 6), regions for transferring the variable are secured in both the DO region 53a and the DI region 53b. Then, on the screen of the list of indexes, the name of the same variable is displayed in the comment field of each of the DO region and the DI region. In this manner, in the present embodiment, the memory region of the controller can be automatically allocated in accordance with the data type of the variable. Thus, the operator does not need to manually allocate the memory, and the memory can be easily allocated.

Further, in the memory region that is not used for the communication of the above-described variables, allocation of arbitrary signals can be performed as in the related art. For example, referring to FIG. 7, the operator can manually allocate signals from the PLC 6 to the indexes from DI [289] onward in the DI region. In this example, the operator allocates a command for starting a specific program of the robot to DI [289]. The operator allocates a command for temporarily pausing the specific program of the robot to DI [290]. Further, the operator allocates a command for aborting the specific program of the robot to DI [291].

Incidentally, in the present embodiment, when communication is performed between the controller 4 of the robot and the PLC 6 while the robot device is carrying out the actual work, the variable information (data) including a numerical value or a character string is converted into a digital signal (bit string of 0s and 1s), or the digital signal is converted into the variable information.

Referring to FIG. 3, at steps 116 to 118, the conversion program for converting the variable information and the digital communication signal is generated in order to perform the periodic digital communication between the controller main body 41 and the PLC 6.

Referring to FIGS. 2 and 3, at step 116, the program generating unit 48 of the controller main body 41 generates the conversion program of the controller 4. Referring to FIG. 2, the program generating unit 48 of the processing unit 45 generates, in the controller main body 41, the conversion program for performing conversion between the variable information and the digital communication signal constituted by “1” and “0”. The program generating unit 48 generates, for example, a conversion program for performing conversion between decimal numerical data and a bit string of a binary digital communication signal.

Further, after converting the digital communication signal received from the PLC 6 into the variable information, the program generating unit 48 generates a conversion program so that the conversion program includes a command for storing the variable information in the memory of the storage 42. In the present embodiment, when the signal received from the PLC 6 is a character string, a conversion program for storing the character string in a character string region of the memory is generated. Further, when the signal received from the PLC 6 is a numerical value, a conversion program for storing the numerical value in a numerical value region of the memory is generated.

Subsequently, at step 117, the function generating unit 49 of the processing unit 45 of the controller 4 generates a function file (FRC_Read_IO.xml) for generating the conversion program in the PLC 6. The function generating unit 49 outputs the function file in a file format readable by the PLC 6. The PLC 6 reads this function file. Similarly to the conversion program of the controller 4, the conversion program of PLC 6 also includes a command for performing conversion between the information relating to the variable based on the data type (numerical value or character string) and the digital communication signal (bit string of 0s and 1s).

The function file includes, for example, a function used in the conversion program of the PLC 6. The function generating unit 49 of the present embodiment generates the function file in the XML format specified in the PLCopen standard. Thus, the PLC 6 of the present embodiment compliant with the PLCopen standard can read the function file by using software prepared in advance.

Subsequently, at step 118, the program generating unit 67 of the processing unit 65 of the PLC 6 generates a conversion program in the PLC 6 based on the function file. As processing by the conversion program of the PLC 6, the digital communication signal received from the controller main body 41 is converted into the variable information including a numerical value or a character string. Alternatively, the variable information transmitted from the PLC 6 to the controller main body 41 is converted into the digital communication signal.

The conversion unit 50 of the controller main body 41 and the conversion unit 68 of the PLC 6 convert the variable information or the digital communication signal based on the respective conversion programs. For example, a numerical value can be byte-converted in accordance with the data type such as USINT, REAL, DINT, or the like. Further, a character string such as STRING can be converted into the digital communication signal, or the digital communication signal can be converted into a character string, for example, based on ASCII conversion.

In the present embodiment, the program generating unit 48 of the controller main body 41 generates a conversion program for performing conversion between the variable information and the digital communication signal based on the basic file. Further, the controller main body 41 generates a function file for generating a conversion program in the PLC 6. Then, the program generating unit 67 of the PLC 6 generates the conversion program using the function file. In this manner, the operator does not need to generate the conversion program, and the conversion program can be automatically generated. As a result, a preliminary setting work of the controller of the robot and the PLC can be easily performed.

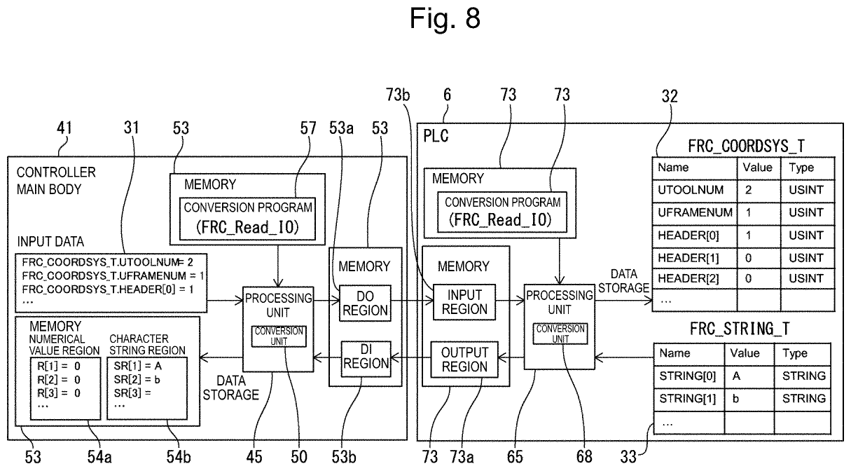

FIG. 8 illustrates a block diagram of the controller main body and the PLC describing the communication of the variables when the robot device carries out the actual work. Referring to FIGS. 2 and 8, the DO region 53a and the DI region 53b are allocated in the memory 53 of the storage 42 of the controller main body 41, as described above. Also in the memory 73 of the arithmetic processing device in the PLC 6, an input region and an output region are secured for inputting and outputting the variables. In the memory 73 of the storage 62, an INPUT region 73b, which is a region for storing signals input to the PLC 6, and an OUTPUT region 73a, which is a region for storing signals output from the PLC 6, are allocated.

In the memory 73 of the PLC 6, a region corresponding to the memory 53 of the controller main body 41 is allocated with respect to the variable to be communicated. The same indexes of the variables as those in the DO region 53a of the memory 53 of the controller main body 41 are allocated in the INPUT region 73b of the PLC 6. The same indexes of the variables as those in the DI region 53b of the memory 53 of the controller main body 41 are allocated in the OUTPUT region 73a of the PLC 6.

The transfer unit 51 of the controller main body 41 periodically transmits, to the PLC 6, information relating to the signals stored in the DO region 53a. The transfer unit 69 of the PLC 6 stores this information in the INPUT region 73b. The transfer unit 69 of the PLC 6 periodically transmits, to the controller main body 41, information relating to the signals stored in the OUTPUT region 73a. The transfer unit 51 of the controller main body 41 stores this information in the DI region 53b. Indexes corresponding to the variables in each of the regions are specified. By periodically repeating the transmission of the signals of the entire input region and the signals of the entire output region, communication of input and output of each of the variables can be performed.

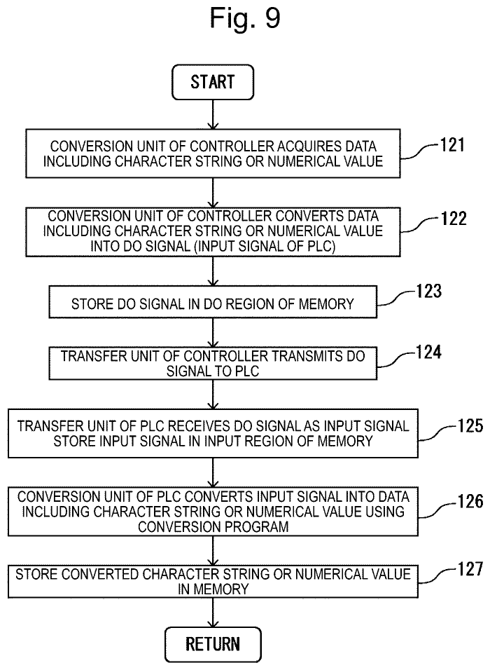

FIG. 9 illustrates a flowchart of control performed when the variable information is transferred from the controller main body to the PLC. Referring to FIGS. 2, 8, and 9, the program generating unit 48 of the controller main body 41 generates a conversion program 57 in advance. The memory 53 of the storage 42 stores the conversion program 57 for the controller main body 41. The program generating unit 67 of the PLC 6 generates a conversion program 75 in advance based on a function file. The memory 73 of the storage 62 stores the conversion program 75 for the PLC 6.

At step 121, the conversion unit 50 of the controller main body 41 acquires input data 31. The input data 31 includes information (numerical value or character string) regarding each of the variables. For example, the conversion unit 50 acquires information in which the variable UTOOLNUM of the structure FRC_COORDSYS_T is 2.

At step 122, the conversion unit 50 of the processing unit 45 converts data including a character string or a numerical value into a DO signal, which is a digital communication signal, based on the conversion program 57. At step 123, the conversion unit 50 stores the digital communication signal in the DO region 53a of the memory 53. In other words, a bit string constituted by 0s and 1s is stored in the DO region 53a of the memory 53.

Subsequently, at step 124, the transfer unit 51 of the controller main body 41 transmits the DO signal to the PLC 6. At step 125, the transfer unit 69 of the PLC 6 receives the DO signal as an INPUT signal of the PLC 6. The transfer unit 69 stores the INPUT signal in the INPUT region 73b of the memory 73. In other words, a bit string constituted by 0s and 1s is stored in the INPUT region 73b of the memory 73.

Subsequently, at step 126, the conversion unit 68 of the PLC 6 acquires the conversion program 75 in the PLC from the memory 73. The conversion unit 68 converts the INPUT signal into data including a character string or a numerical value based on the conversion program 75. In FIG. 8, received data 32 of the variables of the structure FRC_COORDSYS_T is illustrated. Information in which the variable UTOOLNUM is 2, the variable UFRAMENUM is 1, and the like is received from the controller main body 41.

At step 127, the processing unit 65 stores the data including the character string or the numerical value in the storage 62 of the PLC 6. In this example, data of each of the variables indicated in the received data 32 is stored in the memory 73 of the storage 62.

In this manner, the variable information including the numerical value or the character string is converted into a digital communication signal in the controller main body 41, and transmitted to the PLC 6. In the PLC 6, the digital communication signal can be converted into the variable information.

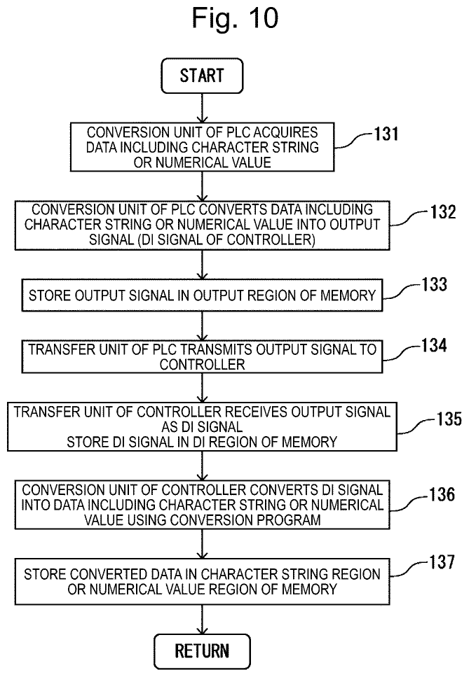

FIG. 10 illustrates a flowchart of control performed when the variable information is transferred from the PLC to the controller main body. Referring to FIGS. 2, 8 and 10, as illustrated in the input data 33, the PLC 6 transfers the variable STRING [0] and the variable STRING [1] of the structure FRC_STRING_T to the controller main body 41. The data type of each of the variable STRING [0] and the variable STRING [1] is STRING, which is the character string type. In this case, the variable STRING [0] is a character “A”, and the variable STRING [1] is a character “b”.

At step 131, the conversion unit 68 of the processing unit 65 of the PLC 6 acquires data (variable information) including a character string or a numerical value. At step 132, the conversion unit 68 converts the data including the character string or the numerical value into an OUTPUT signal, which is an output signal of digital communication of the PLC 6. The OUTPUT signal is constituted by a bit string constituted by 1s or 0s. At step 133, the conversion unit 68 stores the bit string of the OUTPUT signal in the OUTPUT region 73a of the memory 73.

At step 134, the transfer unit 69 of the processing unit 65 of the PLC 6 transmits the OUTPUT signal to the controller main body 41. At step 135, the transfer unit 51 of the controller main body 41 receives the OUTPUT signal as a DI signal. The transfer unit 51 stores the bit string of the DI signal in the DI region 53b of the memory 53.

At step 136, the conversion unit 50 of the controller main body 41 converts the DI signal into data (variable information) including a character string or a numerical value based on the conversion program 57. At step 137, the conversion unit 50 stores the variable information in the memory 53 of the storage 42. In this case, the conversion unit 50 stores a variable of a character string in a character string region 54b. The conversion unit 50 stores a variable of a numerical value in a numerical value region 54a. In this example, the character “A” and the character “b” are stored in the character string region 54b.

In this manner, the variable information including the numerical value or the character string is converted into the digital communication signal in the PLC 6, and transmitted to the controller main body 41. In the controller main body 41, the digital communication signal can be converted into the variable information.

In the above-described embodiment, the signal composed of the bit string is used as the periodic digital communication signal, but the configuration is not limited to this form, and a signal composed of a byte string may be used. In other words, digital communication including a plurality of the signals composed of the byte string may be performed.

The above embodiments can be combined as appropriate. In each of the above-described controls, the order of steps can be changed appropriately to the extent that the function and action are not changed. Further, in each of the above-described drawings, the same or equivalent parts are denoted by the same sign. The above embodiments are examples and do not limit the invention. In addition, the embodiments include the modifications of the embodiments defined in the claims.

1. A controller of a robot, the controller performing communication with a programmable logic controller and comprising:
a storage configured to store a basic file in which a data type of a variable for performing communication between a programmable logic controller and the controller is specified;
a definition file generating unit configured to generate, in a file format readable by the programmable logic controller, a definition file in which the data type of the variable is specified, based on the basic file;
a transfer unit configured to perform periodic digital communication in order to transfer information relating to the variable when driving the robot; and
a memory allocation unit configured to allocate, based on the data type of the variable specified in the basic file, a variable region to an input region for inputting the variable and an output region for outputting the variable in a memory included in the storage.

2. The controller of the robot of claim 1, the controller comprising a conversion unit configured to perform conversion, when communicating with the programmable logic controller, between the information relating to the variable based on the data type and the periodic digital communication signal.

3. The controller of the robot of claim 2, the controller comprising a program generating unit configured to generate a conversion program for performing the conversion between the information relating to the variable based on the data type and the periodic digital communication signal, wherein
the conversion unit performs the conversion between the information relating to the variable based on the data type and the periodic digital communication signal, based on the conversion program generated by the program generating unit.

4. The controller of the robot of claim 1, the controller comprising a function generating unit configured to generate, in the programmable logic controller, a function file for generating a conversion program configured to perform conversion between the information relating to the variable based on the data type and the periodic digital communication signal.
